(19) United States
(12) Patent Application Publication
(10) Pub. No.: US 2024/0290156 A1
(43) Pub. Date: Aug. 29, 2024

(54) METHOD FOR SECURING A MEANS OF ACCESS TO A TARGET AREA BY PEOPLE, WITH DETERMINATION OF THE DIFFICULTY IN OBTAINING BIOMETRIC INFORMATION

(71) Applicant: IDEMIA IDENTITY & SECURITY FRANCE, Courbevoie (FR)

(72) Inventors: Vincent DESPIEGEL, Courbevoie (FR); Christelle BAUDRY, Courbevoie (FR); Stéphane GENTRIC, Courbevoie (FR); Nicolas MORISSON, Courbevoie (FR)

(73) Assignee: IDEMIA IDENTITY & SECURITY FRANCE, Courbevoie (FR)

(21) Appl. No.: 18/586,978

(22) Filed: Feb. 26, 2024

(30) Foreign Application Priority Data
Feb. 27, 2023 (FR) 23 01776

(51) Int. Cl. G07C 9/37; G07C 9/10

(52) U.S. Cl. CPC G07C 9/37; G07C 9/10

(57) ABSTRACT

Method for securing a means of access to a target area by people, comprising, for a person:
in a first area located upstream of the target area, tracking the person when they are moving in the first area in the direction of the target area, by way of a camera observing at least a portion of the first area,
obtaining biometric information in relation to the person being tracked in order to check whether this person corresponds to a pre-registered person,
determining a security indicator indicating a level of difficulty in obtaining biometric information for the person being tracked and checking whether a security condition is satisfied based on the indicator,
generating a warning signal.

### TECHNICAL FIELD

The invention relates to the field of securing access to a target area towards which people are moving. The invention is applicable in securing access to an aircraft, a train, a boat, or even a building.

### PRIOR ART

Access to areas with a certain level of security may be restricted only to people who are authorized to enter said area. For example, when boarding an aircraft, a check is generally carried out (by an operator) on the identity of people and their transport ticket before allowing the people to advance to a means of access to an aircraft (typically an airbridge).

The development of solutions based on biometrics allows an operator to dispense with this check. In a context in which biometrics are used, people wishing to access an aircraft pre-register for a flight with their biometric information (typically a facial image), and recognition of the biometric information gives access to the aircraft without any operator being involved.

Some solutions based on biometrics make it possible to do away with a gate, the recognition taking place during the passage of people through an area in the direction of the aircraft, for example. Such an area may be a corridor observed by cameras, which will track the people and check their biometrics on the images that are acquired.

The prior art discloses corridors through which multiple people are able to pass simultaneously (for example groups of fewer than 4 people) in an area observed by one or more cameras, wherein the biometric information in relation to these people is obtained in order to check that they have actually pre-registered in order to access the aircraft.

The latter solution is the least inconvenient for people moving, without any hindrance such as a gate, but it is also less secure than a check performed by an operator. In fact, this solution is a solution in which the gates are open by default and are able to close if an unauthorized person is present.

There are few sufficiently secure solutions in which a group of people are able to pass (and not people one by one).

The following documents are known from the prior art:
US 20210358244,
ES 2860352,
U.S. Pat. No. 11,080,955,
EP3494553,
KR20170111804, and
EP3179452.

The solutions described in these documents are not designed to let multiple people pass through, or are not sufficiently secure or are too inconvenient for people.

### AIM AND SUMMARY OF THE INVENTION

The present invention addresses this need by proposing a method for securing a means of access to a target area by people, comprising, for a person (for example one person out of multiple people moving towards the target area):
in a first area located upstream of the target area, tracking the person when they are moving in the first area in the direction of the target area, by way of a camera observing at least a portion of the first area (multiple cameras may be used, with overlapping fields of observation, for example to cover the entire first area),
obtaining biometric information (for example information allowing facial recognition) in relation to the person being tracked (and therefore by way of the tracking that uses the camera) in order to check whether this person corresponds to a pre-registered person,
determining a security indicator indicating a level of difficulty in obtaining biometric information for the person being tracked (and thus by way of the tracking that uses the camera) and checking whether a security condition is satisfied based on the indicator,
if the person corresponds to a pre-registered person and if the security condition relating to the indicator is not satisfied, then generating a warning signal, and if the person does not correspond to a pre-registered person, then generating a warning signal (for example the same warning signal as that generated if the security condition relating to the indicator is not satisfied, or a different warning signal).

The invention thus proposes to use an additional indicator and satisfying of an additional security condition to generate or not generate a warning signal. In particular, this warning signal is generated even though the person has been recognized through their biometrics. In fact, the security indicator may indicate that an excessively low security level was achieved when obtaining biometric information, since said biometric information was difficult to obtain.

The security indicator actually indicates a level of cooperation of the person when moving towards the target area, this cooperation being able to be measured by the difficulty involved in obtaining the biometric information.

The warning signal, for example that generated if the security condition relating to the indicator is not satisfied, may be a visual signal, an acoustic signal, or else a signal that triggers an actuator (for example to close a means of access). With this warning signal, an operator may be invited to carry out a check on the identity of the person. Said warning signal is preferably output in the vicinity of the exit of the first area.

According to one particular mode of implementation, the warning signal designates the person.

For example, the warning signal may be output by way of a display module on which the person is designated.

For example, if the display module comprises augmented reality glasses (for example Hololens (registered trademark) augmented reality glasses), a marker may appear in the vicinity of the person on these glasses, such that the operator wearing these glasses perceives the warning and the person in question.

If the display module is a screen, this screen may show the images observed by the camera (or another camera) and display a marker in the vicinity of the person visible in these images.

According to one particular mode of implementation, the method comprises generating another warning signal designating another person for whom biometric information was obtained for a check showing that this person corresponds to a pre-registered person (in other words, the check based on biometrics shows that this other person is indeed a pre-registered person) and for whom the security condition is satisfied.

In this particular embodiment, a warning designates a person who however corresponds to a pre-registered person, that is to say whose biometric identity is verified and for whom the security condition was satisfied: this makes it possible to limit the impact of a bias in the use of the security indicator.

The other person is also a person who is moving or has moved through the first area in the direction of the target area.

According to one particular embodiment, the other person is chosen by way of a random datum.

In other words, the other person is chosen randomly, thereby further limiting the impact of a bias in determining the security indicator. In fact, this not only limits the impact of a bias relating to the determination of the security indicator, but also limits the impact of a bias in obtaining biometric information and/or in the check based on biometrics, or even an operator bias if an operator also has the ability to generate warning signals.

Therefore, the other person may be chosen on a regular basis, that is to say by repeating the choice of another person at a given time interval or of a given number of people who have transited from the first area to the fixed target area, so as to limit the impact on people moving towards the target area. Advantageously, the occurrence of making the choice may also be conditional on the workload of the operators.

According to one particular mode of implementation, the security indicator is based on a visibility of the face of the person.

The visibility of a person's face may be affected by a viewing angle (a person turns their head away from a camera), by an accessory being worn (glasses, scarf, mask, etc.). A poorly visible face makes it difficult to obtain biometric information, in particular if using facial recognition technology.

For example, the security indicator may be based on one of the methods described in the document “Face Image Quality Assessment: A Literature Survey” (TORSTEN SCHLETT ET AL, ACM Computing Surveys, Volume 54 Issue 10 Jan. 2022). Other methods may be used.

Facial visibility may also be defined using the ISO/IEC 39794-5 standard, Part 5, Annex D.1 (December 2019), and compliance with this standard may be evaluated in order to determine facial visibility.

According to one particular mode of implementation, the warning signal or the other warning signal, when it exists, does not comprise any additional biometric information in relation to the person or the other person, additional biometric information being biometric information that differs from the obtained biometric information.

Additional biometric information may be information from a database, which may not be available in the environment where the present method is implemented (typically, the environment may be an airport). The choice of additional biometric information is made according to the environment.

By way of indication, in this embodiment, the warning signal or the other warning signal not comprising any additional biometric information may be an image of the person acquired for example when they pass through the first area, and it might not contain any identity information (name, etc.) or fingerprint information.

For example, the signal may be a marker visible in the vicinity of the person on augmented reality glasses. An operator will thus not have access to any sensitive datum in terms of security, but will be able to carry out an identity check based on an identity document, if necessary.

According to one particular mode of implementation, the warning signal is intended to be produced in a second area located between the first area and the target area, and possibly, the other signal is intended to be output in a second area located between the first area and the target area.

The first area is the area in which people are moving in order to allow them to be recognized based on biometrics. In the second area, other people, such as operators, may be present. It is in this second area where the warning signal is output (for example, it is visible on a display module present in the second area), or else it is emitted such that it is audible in the second area if it is an acoustic signal.

According to one particular mode of implementation, a third area is separated from the first area by way of a separation that prevents people from passing from the first area and possibly from the second area to the third area (when the second area is provided, for example), the third area being outside a tracking field of the camera and a field for obtaining biometric information (typically in the first area), and the third area leads to the target area or to the second area, and comprising an inspection gate located before the means of access to the target area or to the second area.

The third area is an alternative area to the first area (and possibly to the second area). For people who have not previously shared their biometric information, passing through the third area allows access to the target area, but by passing through an inspection gate that does not require pre-registration. For example, an operator may be present at the inspection gate.

By way of indication, the method may comprise generating another warning signal designating a person who has moved through the third area.

According to one particular mode of implementation, access-blocking gates are put into a blocked state based on the result of the step of satisfying the security condition (typically, if multiple security conditions are not satisfied) and/or on the result of the step of checking a biometric match (typically, if multiple people do not correspond to a pre-registered person) of a plurality of people.

These access-blocking gates may be located between the first area and the target area, in particular between the second area and the target area.

In this mode of implementation, it will be considered that the satisfying of the security condition and that the check on the biometric match of the person are problematic for a plurality of people, and access to the target area is blocked completely by controlling the access-blocking gates. For example, the blocking gates may be put into a blocked state if, during a given period of time, a number of people greater than a given threshold (for example equal to a number of operators capable of carrying out checks) has led to the generation of warning signals (security condition not satisfied or biometric match failed).

One particular mode of implementation comprises, for multiple people:
in the first area located upstream of the target area, tracking the multiple people when they are moving in the first area in the direction of the target area, by way of the camera,
obtaining biometric information in relation to each person being tracked from among the multiple people in order to check whether each person corresponds to a pre-registered person,
determining the security indicator for each person being tracked and checking whether a security condition is satisfied based on the indicator for each person being tracked,
for each person being tracked, if the person corresponds to a pre-registered person and if the security condition relating to the indicator is not satisfied, then generating a warning signal, and for each person who does not correspond to a pre-registered person, then generating a warning signal (for example the same warning signal as that generated if the security condition relating to the indicator is not satisfied, or a different warning signal).

Thus, multiple people are tracked and, as soon as the security condition is not satisfied for a pre-registered person, a warning is emitted.

This warning may designate the person from among the multiple people.

According to one mode of implementation, the access-blocking gates are put into a blocked state based on the satisfying of the security condition and on the check on the biometric match of the multiple people.

For example, “based on” may be understood to mean that a value based on the indicators of multiple people and the check on a match of the multiple people is compared to a given threshold. For example, beyond a given number of people with an unsatisfied security condition and beyond a given number of people who are not pre-registered, access to the target area may be completely blocked.

According to one particular mode of implementation, the target area is a means of access to an aircraft or a means of access to a train or a means of access to a boat or a means of access to a building.

The invention is particularly well-suited to these means of access.

The invention also proposes a device for securing a means of access to a target area by people, comprising:
a module for obtaining an image stream from a camera observing at least part of
a first area in which a person is moving in the direction of the target area,
a module for tracking the person by way of the camera,
a module for obtaining biometric information in relation to the person being tracked, configured to check whether this person corresponds to a pre-registered person,
a module for determining a security indicator for the person, configured to check whether a security condition relating to the indicator is satisfied,
a module configured to generate a warning signal if the person corresponds to a pre-registered person and if the security condition relating to the indicator is not satisfied, and to generate a warning signal if the person does not correspond to a pre-registered person.

This device may be configured to implement all of the modes of implementation of the method as described above.

For example, this method may have a computer system structure, and the modules may be implemented by way of computer program instructions stored in a non-volatile memory of the computer system, which instructions, when they are executed by a processor of the computer system, execute the steps of the method as described above.

The invention also proposes a system comprising the security device defined above and said camera (possibly a plurality of cameras).

In this system, the camera and the device are in communication.

The invention also targets an installation comprising the system as defined above and the first area.

System comprising a security device as defined above and said camera.

According to one particular embodiment, the system furthermore comprises a module for outputting the generated warning signal if the person corresponds to a pre-registered person and if the security condition relating to the indicator is not satisfied, and/or if the person does not correspond to a pre-registered person, the module for outputting the warning signal comprising augmented reality glasses (for example Hololens (registered trademark) augmented reality glasses) or a tablet (a tablet with a screen) or a warning gate equipped with a signalling device (for example in the form of a gate as found at the exit of a shop, or else in the form of a display terminal).

Installation comprising the system as defined above and the first area.

The installation therefore comprises both the system and this area, which may be an area of a building.

The installation may comprise the second area and/or the third area defined above.

According to one particular embodiment, the target area is a means of access to an aircraft or a means of access to a train or a means of access to a boat or a means of access to a building.

### BRIEF DESCRIPTION OF THE DRAWINGS

Other features and advantages of the present invention will become apparent from the description given below, with reference to the appended drawings, which illustrate one example thereof devoid of any limiting features.

In the figures:

FIG. 1 schematically shows the steps of a method according to one example.

FIG. 2 shows another example in which multiple people are tracked.

FIG. 3 shows a device and a system according to one example.

FIG. 4 shows an airport installation.

FIG. 5 shows a railway station installation.

### DETAILED DESCRIPTION OF ONE EMBODIMENT

A description will now be given of a method and a system for securing a means of access to a target area by people.

This method and this system are particularly suitable for target areas such as a means of access to an aircraft (typically an airbridge) or a means of access to a train (a platform) or a means of access to a boat or a means of access to a building.

Therefore, the method and the system target the movement of people, allowing their identity to be checked based on biometrics, in an area in which the people move without any hindrance and in the direction of the target area, in order to allow their identity to be checked. The method and the system are therefore applicable in secure means of access for which it is not necessary to systematically check the identity of people manually. These means of access may be called “free flow” means of access.

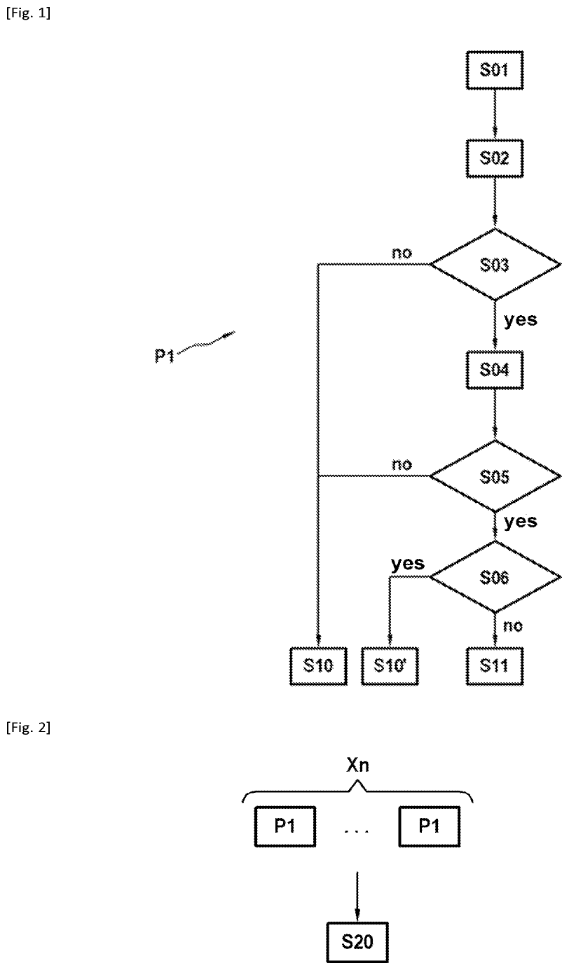

FIG. 1 schematically shows, in the form of a flowchart, the steps of a method for securing a means of access to a target area by people, these steps relating to a person, for example one person from among multiple people moving towards the target area (method P1). “Move” is understood to mean moving on foot or using a mobility aid such as a wheelchair, etc.

The method P1 is implemented using one or more observation cameras, each observing a first area. The first area may be a corridor in which multiple people are able to move simultaneously and even side by side.

In a first step S01, the person is tracked, for example by using image processing algorithms that identify people and carry out tracking. A person skilled in the art will be able to choose an algorithm able to be used for this purpose, which makes it possible to locate where one and the same person is located on a video stream. The video stream may comprise images from multiple cameras, for example with overlapping fields of observation and fused signals from the cameras, so as to be able to consolidate the tracking of the people.

It may be noted that the tracking of a person may comprise tracking their whole body and/or just their face.

In a second step S02, biometric information in relation to the person being tracked is obtained. This makes it possible, in step S03, to check the pre-registered character of the person.

For example, to carry out step S02, it is possible to use any known facial recognition algorithm, in particular based on the images acquired when tracking people during step S01 using the camera 400. For example, it is possible to use an algorithm that delivers a signature, in particular a biometric signature, that is used to check, in step S03, whether the person is pre-registered in a database, this pre-registration also using biometrics.

If the person is not pre-registered, warning step S10 is implemented.

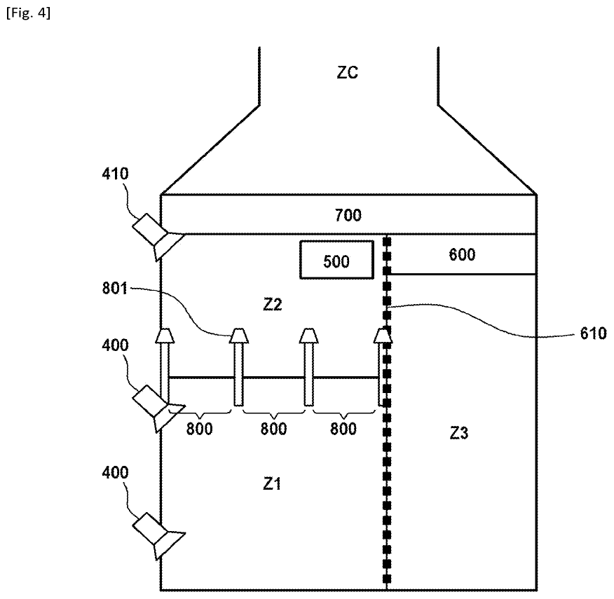

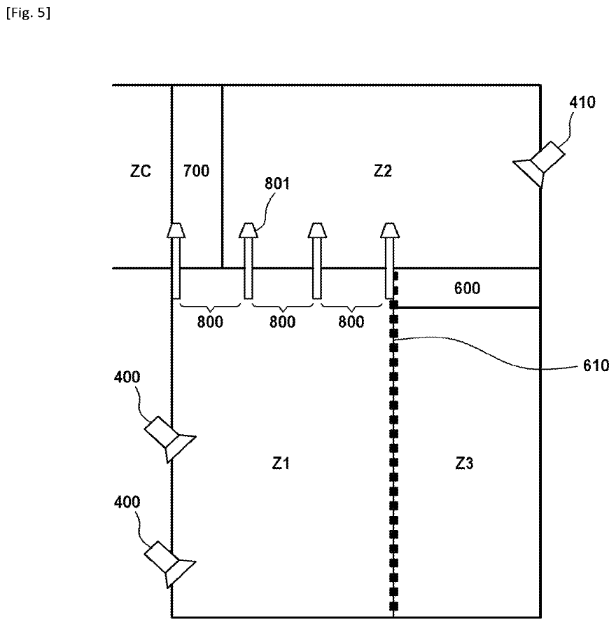

It may be noted that step S10 may be implemented only if the person has passed through the first area so as to reach either the target area or the second area, if this is present, as is the case in the examples described with reference to FIGS. 4 and 5. This mode of implementation is advantageous for a first area that is said to be “open”, such as a station hall.

The warning may be a global warning that does not designate the person from among multiple people moving towards the target area. For example, the warning signal may be output by way of a warning gate located at the exit of the first area, for example between the first area and a second area, this warning gate being equipped with a signalling device that flashes/makes noise when the warning signal is generated (these warning gates being similar to those located at the exit of a shop). Multiple warning gates may be used. The warning signal may also be output on a display module such as a tablet screen or augmented reality glasses (for example Hololens (registered trademark) augmented reality glasses). Several of these warning output methods may be combined.

Preferably, the warning designates the person. For example, the warning signal may be output by way of a display module on which the person is designated.

For example, if the display module comprises augmented reality glasses (for example Hololens (registered trademark) augmented reality glasses), a marker may appear in the vicinity of the person on these glasses, such that the operator wearing these glasses perceives the alert. If the display module is a screen, this screen may show the images observed by the camera (or another camera) and display a marker in the vicinity of the person visible in these images.

For a warning that designates a person, it is also possible to use one or more warning gates, configured such that the warning is output when the person passes through (it should be noted that the width of the warning gates is advantageously chosen such that multiple people at a time pass through a warning gate, leaving in particular enough room for the passage of a person with reduced mobility).

The warning that designates a person may be configured such that an operator is invited to carry out a check on the identity of the unregistered person and, to this end, it is output such that an operator is able to perceive it.

For a pre-registered person, it is possible to implement step S04 of determining a security indicator indicating a level of difficulty in obtaining biometric information for the person being tracked, and it is checked whether a security condition is satisfied based on the indicator.

In the present example, the indicator relates to a visibility of the face of the person. Measuring this visibility yields information about the level of cooperation of the person with the access system based on biometrics.

In fact, concealing the face with glasses, a hat, etc. may affect the obtainment of the biometric information. This measurable information accurately reflects the level of cooperation of the person.

By way of indication, it is possible to use one of the methods described in the document “Face Image Quality Assessment: A Literature Survey” (TORSTEN SCHLETT ET AL, ACM Computing Surveys, Volume 54 Issue 10 Jan. 2022).

In step S05, it is checked whether a security condition is satisfied based on the indicator. This step may comprise a comparison with a given threshold.

If the security condition is not satisfied, step S10 of generating a warning signal, described above, is implemented.

In other words, the person is a pre-registered person, but their cooperation is not at an expected level, and the warning signal is generated.

If the security condition is satisfied, it is possible to implement step S06, in which it is decided whether or not to generate another warning signal according to a random datum.

If it is decided to generate a signal on the basis of the random datum, step S10′ of generating another warning signal is implemented.

Step S10′ is analogous to step S10. Preferably, the signals generated by steps S10′ and S10 are identical, such that it is not possible to distinguish between a justified warning in view of the checks S03 and S05 and a warning based on the random datum. These signals may be output in the same way.

The use of a random datum makes it possible to avoid the impact of a bias on the checking of the biometric information or the determination of the security indicator.

If it is not decided to generate a signal on the basis of the random datum, the method ends in step S11.

FIG. 2 shows one example in which the method P1 has been implemented for n people, the n people passing through the first area in the direction of the target area.

This corresponds to implementing a method comprising, for n people:
in the first area located upstream of the target area, tracking the multiple people when they are moving in the first area in the direction of the target area, by way of the camera,
obtaining biometric information in relation to each person being tracked from among the multiple people in order to check whether each person corresponds to a pre-registered person,
determining said security indicator for each person being tracked and checking whether a security condition is satisfied based on the indicator for each person being tracked,
for each person being tracked, if the person corresponds to a pre-registered person and if the security condition relating to the indicator is not satisfied, then generating a warning signal.

Subsequently, it is possible to implement step S20, comprising putting access-blocking gates into a blocked state based on all of the instances of satisfying of the security condition and on all of the checks on the match of the n people.

These blocking gates may be arranged between the first area and the target area, in particular between a second area and the target area, as will be seen in FIGS. 4 and 5 described later on.

For example, beyond a given threshold of people for whom the security condition was not satisfied, the blocking gates may be put into a blocked state. Beyond another given threshold of people who do not correspond to pre-registered people, the blocking gates may be put into a blocked state.

In the steps shown in FIGS. 1 and 2, when warning signals are generated, it is possible not to transmit any biometric information in relation to the people to whom the warnings relate. This ensures the security of the biometric information while still allowing operators to carry out checks on people with for example their identity documents. This may be achieved with a warning signal that indicates the position of a person designated by a warning (such as a marker). In fact, no information allowing step S03 to be implemented is transmitted.

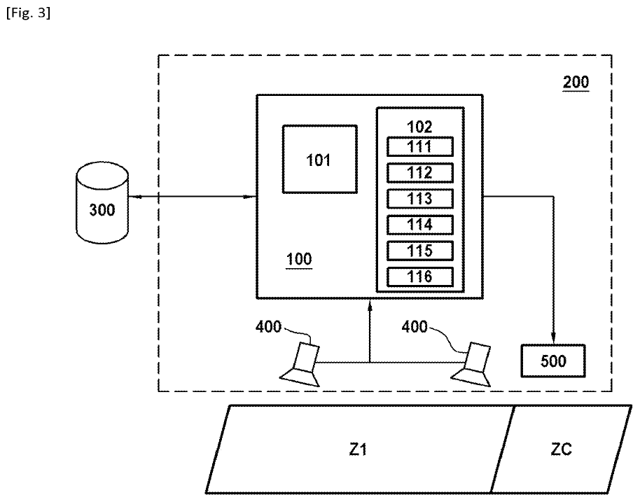

FIG. 3 shows a system 200 comprising a device 100 configured to implement the method steps described above.

The system 200 and the device are configured to secure access to the target area ZC shown in the figure, from the first area Z1.

To this end, the system comprises cameras 400 that observe the first area, here one portion each.

The device 100 has a computer system structure and comprises a processor 101 and a non-volatile memory 102 that contains computer program instructions.

The device 100 is in communication (for example via a communication network) with a biometric database 300 storing biometric information in relation to pre-registered people. The biometric database may be centralized, for example managed by a state, or else local and managed by the entity hosting the target area (typically the airport).

The system 200 also comprises a module 500 configured to output the generated warnings, for example a display device (screen, augmented reality glasses).

Instructions have been stored in the non-volatile memory:
instructions 111 for obtaining an image stream from a camera observing at least part of the first area Z1 in which a person is moving in the direction of the target area ZC, forming an obtaining module when they are executed by the processor,
instructions 112 for tracking the person by way of the cameras 400 and determining their signature, in particular their biometric signature, forming a module for tracking the person when they are executed by the processor,
instructions 113 for obtaining biometric information in relation to the person being tracked and for checking whether this person corresponds to a pre-registered person, in particular by comparing the determined signature with the base of pre-registered people 300, forming a biometric matching module when they are executed by the processor,
instructions 114 for determining a security indicator indicating a level of difficulty in obtaining biometric information for the person, the instructions 114 furthermore being instructions for checking whether a security condition relating to the indicator is satisfied, in particular by comparing the indicator to a threshold, forming a determination module when they are executed by the processor,
instructions 115 for generating a warning signal if the person corresponds to a pre-registered person and if the security condition relating to the indicator is not satisfied, and for generating a warning signal if the person does not correspond to a pre-registered person, forming a generation module when they are executed by the processor.

The non-volatile memory 102 also contains instructions 116 that, when they are executed by the processor 101, implement step S20 described above.

The non-volatile memory may furthermore contain instructions for generating another warning signal for a randomly chosen person, in order for example to implement step S10′ described above.

FIG. 4 shows a target area configuration, which may be that for an airport (or a port).

For example, the target area may be an airbridge leading to an aircraft (not shown).

Two cameras 400 are shown for the first area. For example, it is possible to use cameras arranged at a height of 2 m, preferably distributed evenly so as to entirely cover the volume/space of the area 1. By way of indication, and if multiple cameras are used, they may have overlapping fields of observation (this makes it possible to fuse the data from the cameras), this being able to be achieved by choosing cameras with appropriate fields of observation (for example fish-eye/wide-angle/etc.). Preferably, the entire first area is observed by the cameras.

Here, the first area, in the direction of movement going from bottom to top in the figure, leads to a second area Z2. The second area Z2 is an area in which the module 500 is arranged so that the warning is output in this area.

For example, one or more operators may be present in this area and, on the basis of the warning, they may carry out a check on people designated by warnings.

It is possible to reach the target area ZC by way of an alternative path, here a third area Z3. The third area is separated from the first area by way of a separation 610 that prevents people from passing from the first area and from the second area to the third area.

The separation 610 may or may not be opaque, such that the third area Z3 is outside the field of observation of the cameras 400, that is to say outside the field for automated biometric tracking and inspection. Biometric information in relation to people moving in the third area Z3 is thus not used. This area makes it possible, for personal reasons, not to have to transmit information for pre-registration. On the other hand, an inspection gate 600 is arranged between the third area Z3 and the second area Z2, for example with an operator.

Optionally, a camera 410 observing the second area has also been arranged, making it possible for example, on the basis of the tracking carried out in the first area, to continue this tracking and to produce warnings that clearly designate the correct people, this being particularly useful in the case of a large group of uncooperative people.

Between the second area and/or the third area, on the one hand, and the target area, on the other hand, there have been arranged access-blocking gates 700 that are able to be controlled during step S20.

These access-blocking gates 700 may, when they are open, allow easy access, typically with a width of the preferred order of at least 1.20 m, depending on the configuration of the location (train door, boarding gate, etc.).

Warning gates 800 have been shown in the figure between the first area Z1 and the second area Z2. These warning gates 800 are able to output a warning signal like the module 500 (which they may replace), for example with a signalling device 801 that produces a luminous or acoustic signal (mounted here on the warning gates 800, but which may be placed elsewhere). The outputting of the warning signal may be triggered for example when a person designated by a warning passes through one of the warning gates 800, of narrower width than the width of the area 1 (here, for the entire area 1, three warning gates have been shown). These warning gates 800 may, when they are open, allow easy access, typically with a width of the order of 1.20 m to 1.50 m. FIG. 5 shows another configuration, more suitable for a means of access to a train, in which the third area and the first area lead to the second area. The access-blocking gates are arranged between the second area and the target area ZC.

As illustrated in FIGS. 4 and 5, the warning gates 800 are initially open and are open by default, not necessarily comprising closure means, whereas the access-blocking gates 700 are initially open and are open by default, but comprise closure means (for example door leaves, a sliding closure) that are then moved to the closed position when the access-blocking gates 700 are put S20 into a blocked state, so as to prevent access to the target area ZC.

1. A method for securing a means of access to a target area by people, comprising, for a person:
in a first area located upstream of the target area, tracking the person when they are moving in the first area in the direction of the target area, by way of a camera observing at least a portion of the first area,
obtaining biometric information in relation to the person being tracked in order to check whether this person corresponds to a pre-registered person,
determining a security indicator indicating a level of difficulty in obtaining biometric information for the person being tracked and checking whether a security condition is satisfied based on the indicator,
if the person corresponds to a pre-registered person and if the security condition relating to the indicator is not satisfied, then generating a warning signal, and if the person does not correspond to a pre-registered person, then generating a warning signal.

2. The method according to claim 1, wherein the warning signal designates the person.

3. The method according to claim 2, comprising generating another warning signal designating another person for whom biometric information was obtained for a check showing that this person corresponds to another pre-registered person and for whom the security condition is satisfied.

4. The method according to claim 3, wherein the other person is chosen by way of a random datum.

5. The method according to claim 1, wherein the security indicator indicating a level of difficulty in obtaining biometric information for the person being tracked is based on a visibility of the face of the person being tracked.

6. The method according to claim 1, wherein the warning signal does not comprise any additional biometric information in relation to the person or the other person, additional biometric information being biometric information that differs from the obtained biometric information.

7. The method according to claim 1, wherein the warning signal is intended to be produced in a second area located between the first area and the target area.

8. The method according to claim 1, wherein a third area is separated from the first area by way of a separation that prevents people from passing from the first area and possibly from the second area to the third area,
the third area being outside a tracking field of the camera and a field for obtaining biometric information, and
the third area leads to the target area or to the second area, and comprising an inspection gate located before the means of access to the target area or to the second area.

9. The method according to claim 1, comprising putting access-blocking gates into a blocked state based on the satisfying of the security condition and on the check on the biometric match of a plurality of people.

10. The method according to claim 1, comprising, for multiple people:
in the first area located upstream of the target area, tracking the multiple people when they are moving in the first area in the direction of the target area, by way of the camera,
obtaining biometric information in relation to each person being tracked from among the multiple people in order to check whether each person corresponds to a pre-registered person,
determining said security indicator for each person being tracked and checking whether a security condition is satisfied based on the indicator for each person being tracked,
for each person being tracked, if the person corresponds to a pre-registered person and if the security condition relating to the indicator is not satisfied, then generating a warning signal, and for each person who does not correspond to a pre-registered person, then generating a warning signal (for example the same warning signal as that generated if the security condition relating to the indicator is not satisfied, or a different warning signal).

11. The method according to claim 9, comprising putting the access-blocking gates into a blocked state based on the satisfying of the security condition and on the check on the biometric match of the multiple people.

12. The method according to claim 1, wherein the target area is a means of access to an aircraft or a means of access to a train or a means of access to a boat or a means of access to a building.

13. A device for securing a means of access to a target area by people, comprising:
a module for obtaining an image stream from a camera observing at least part of a first area in which a person is moving in the direction of the target area,
a module for tracking the person by way of the camera,
a module for obtaining biometric information in relation to the person being tracked, configured to check whether this person corresponds to a pre-registered person,
a module for determining a security indicator indicating a level of difficulty in obtaining biometric information for the person, configured to check whether a security condition relating to the indicator is satisfied,
a module configured to generate a warning signal if the person corresponds to a pre-registered person and if the security condition relating to the indicator is not satisfied, and
to generate a warning signal if the person does not correspond to a pre-registered person.

14. The system comprising a security device according to claim 13 and said camera.

15. The system according to claim 14, furthermore comprising a module for outputting the generated warning signal if the person corresponds to a pre-registered person and if the security condition relating to the indicator is not satisfied, and/or if the person does not correspond to a pre-registered person, the module for outputting the warning signal comprising augmented reality glasses or a tablet or a warning gate equipped with a signalling device.
